(19) United States
(12) Patent Application Publication
(10) Pub. No.: US 2010/0021806 A1
(43) Pub. Date: Jan. 28, 2010

(54) Reserve Battery

(75) Inventors: Steve Simon, Middletown, NJ (US); Victor Lifton, Bridgewater, NJ (US); Fred Allen, Princeton Junction, NJ (US)

Correspondence Address: NEUSTEL LAW OFFICES, LTD., 2534 SOUTH UNIVERSITY DRIVE, SUITE 4, FARGO, ND, 58103, US

(73) Assignee: MPHASE TECHNOLOGIES, INC.

(21) Appl. No.: 12/499,547

(22) Filed: Jul. 8, 2009

Related U.S. Application Data
(60) Provisional application No. 61/079,168, filed on Jul. 9, 2008.

(51) Int. Cl. H01M 6/36

(52) U.S. Cl. 429/116

(57) ABSTRACT

A reserve battery having a prolonged shelf life that may be used in a wide variety of consumer related and non consumer related electrical devices. The reserve battery includes an outer enclosure, an internal breaking element extending directly from an inner surface of the outer enclosure and a breakable barrier positioned within the outer enclosure. At least one reservoir and at least one chamber are defined by the breakable barrier and the outer enclosure. An electrolyte material is contained within the reservoir and a plurality of electrodes are contained within the chamber. The plurality of electrodes receive the electrolyte material to activate the battery when manual pressure is applied to the internal breaking element to move the internal breaking element inwardly thus breaking the breakable barrier to allow passage of the electrolyte from within the reservoir to saturate the separator within the chamber.

### CROSS REFERENCE TO RELATED APPLICATIONS

I hereby claim benefit under Title 35, United States Code, Section 119(e) of U.S. provisional patent application Ser. No. 61/079,168 filed Jul. 9, 2008. The 61/079,168 application is currently pending. The 61/079,168 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to reserve batteries and more specifically it relates to a reserve battery for efficiently providing a prolonged shelf life via a barrier that may be broken with a low energy mechanical force thus allowing the reserve battery to be used in a wide variety of consumer related and non consumer related electrical devices.

2. Description of the Related Art

Any discussion of the related art throughout the specification should in no way be considered as an admission that such related art is widely known or forms part of common general knowledge in the field.

Reserve batteries have been around for many years and are generally used as specialty batteries which have a very long shelf life for military applications, wherein the shelf life refers to the period prior to usage of the battery power. In many instances, reserve batteries have been large, bulky, heavy and expensive to build, and contain large areas of wasted space due to mechanical separators (which require a large force, such as a hammer or explosion, to break in order for activation). For these reasons, the production and use of reserve batteries has generally been less than optimal and also has been restricted to the military or large organizations. Because of the inherent problems with the related art, there is a need for a new and improved micro reserve battery for efficiently providing a prolonged shelf life via a barrier that may be broken with a low energy mechanical force thus allowing the reserve battery to be used in a wide variety of consumer related and non consumer related electrical devices.

### BRIEF SUMMARY OF THE INVENTION

A system for efficiently providing a prolonged shelf life via a barrier that may be broken with a low energy mechanical force thus allowing the reserve battery to be used in a wide variety of consumer related and non consumer related electrical devices. The invention generally relates to reserve batteries which include an outer enclosure, an internal breaking element that moves inwardly and a breakable barrier positioned within the outer enclosure. At least one reservoir and at least one chamber are defined by the breakable barrier and the outer enclosure. An electrolyte material is contained within the reservoir and a plurality of electrodes are contained within the chamber. The plurality of electrodes receive the electrolyte material to activate the battery when manual pressure is applied to the internal breaking element to move the internal breaking element inwardly thus breaking at least a portion the breakable barrier to allow passage of the electrolyte from within the at least one reservoir to saturate the separator within the at least one chamber.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of one embodiment of the outer enclosure comprised of a flexible pouch.

FIG. 2a is a side sectional view of a first embodiment of the battery with the inner surface of the outer enclosure being used as the breaking elements.

FIG. 2b is a side sectional view of the first embodiment of the battery showing the inner surface of the outer enclosure being used as the breaking element to rupture the barrier via pressure being applied to the outer surface of the outer enclosure.

FIG. 3 is a side sectional view of a second embodiment of the battery with contact pins extending inwardly from the outer enclosure being used as the breaking elements.

FIG. 4 is a side sectional view of a third embodiment of the battery with contact pins extending inwardly from the outer enclosure being used as the breaking elements and illustrating fill ports fluidly connected to the reservoir and terminals electrically connected to the electrodes.

FIG. 5a is a side sectional view of a fourth embodiment of the battery with a spike extending from a movable inner support below the inner surface of the outer enclosure to be used as the breaking elements, and enclosing the reservoir between a first barrier and a second barrier.

FIG. 5b is a side sectional view of the fourth embodiment of the battery with a spike extending from a movable inner support below the inner surface of the outer enclosure to be used as the breaking elements, and enclosing the reservoir between a first barrier and a second barrier, wherein the first barrier and the second barrier are being broken thus releasing the electrolyte from the reservoir via pressure being applied to the outer surface of the outer enclosure.

FIG. 6 is a side sectional view of a fifth embodiment of the battery with a spike extending from a push button actuator, and enclosing the reservoir between a first barrier and a second barrier.

FIG. 7a is a side sectional view of an alternate embodiment of the reservoir showing the inner enclosure being used to seal the electrolyte between a first barrier and a second barrier.

FIG. 7b is a side sectional view of the alternate embodiment of the reservoir as shown in FIG. 7a showing the inner enclosure and one of the barriers being ruptured thus releasing the electrolyte via pressure being applied to the outer surface of the inner enclosure.

FIG. 7c is a side sectional view of the alternate embodiment of the reservoir as shown in FIG. 7a illustrating a sixth embodiment of the battery showing the inner enclosure being positioned within an outer enclosure, wherein the inner enclosure is ruptured via pressure applied to the outer enclosure or actuator extending through the outer enclosure.

FIG. 8a is an upper perspective view of the battery being used within a flashlight.

FIG. 8b is a side sectional view of the battery being used within a flashlight illustrating a seventh embodiment of the battery showing the barrier having a breakable portion aligned with the breaking element and a non breakable portion that surrounds the electrode chamber.

FIG. 8c is a side sectional view of the battery being used within a flashlight illustrating the seventh embodiment of the battery showing the barrier having a breakable portion aligned with the breaking element and a non breakable portion that surrounds the electrode chamber, wherein the breakable portion is being ruptured via pressure applied to the push button actuator.

FIG. 9 is a top view of a sheet of a plurality of outer enclosures secured to a housing, wherein the housing and outer enclosures comprise a bubble wrap sheet structure.

FIG. 10 is an exploded side sectional view of an eighth embodiment of the battery showing the first assembly, the second assembly, and the third assembly.

FIG. 11a is a side sectional view of the eighth embodiment of the battery assembled.

FIG. 11b is a side sectional view of the eighth embodiment of the battery in use where the electrolyte is released from the inner enclosure to be transferred through the porous barrier and come in contact with the electrodes below.

FIG. 12 is a side sectional view of a ninth embodiment of the battery showing the inner enclosure only having a bottom layer, wherein the top layer surrounding the electrolyte is the outer enclosure.

### DETAILED DESCRIPTION OF THE INVENTION

### A. Overview

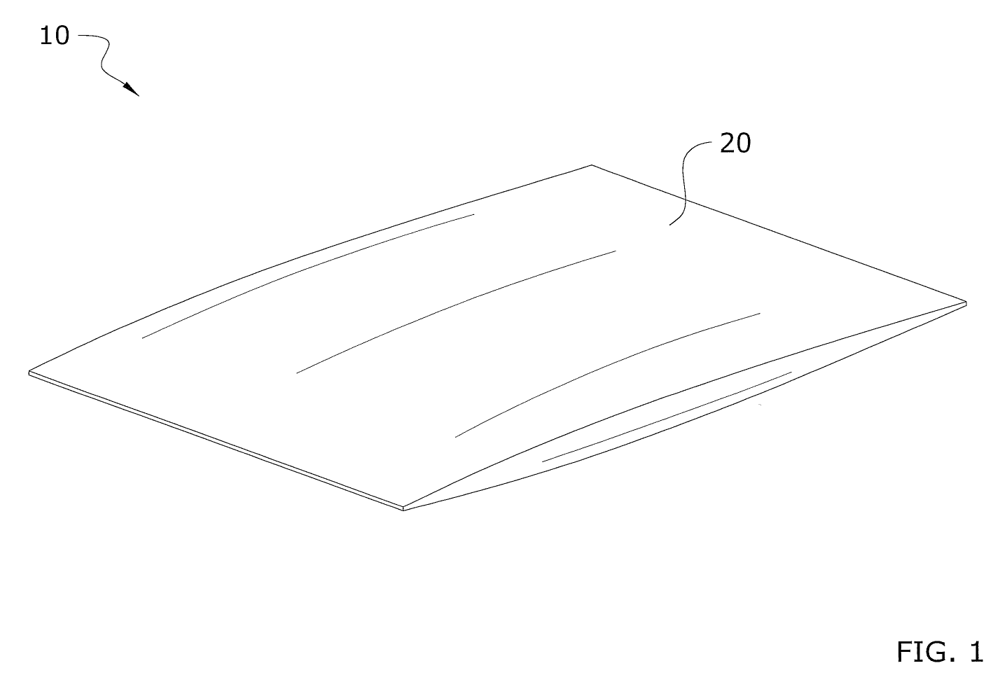

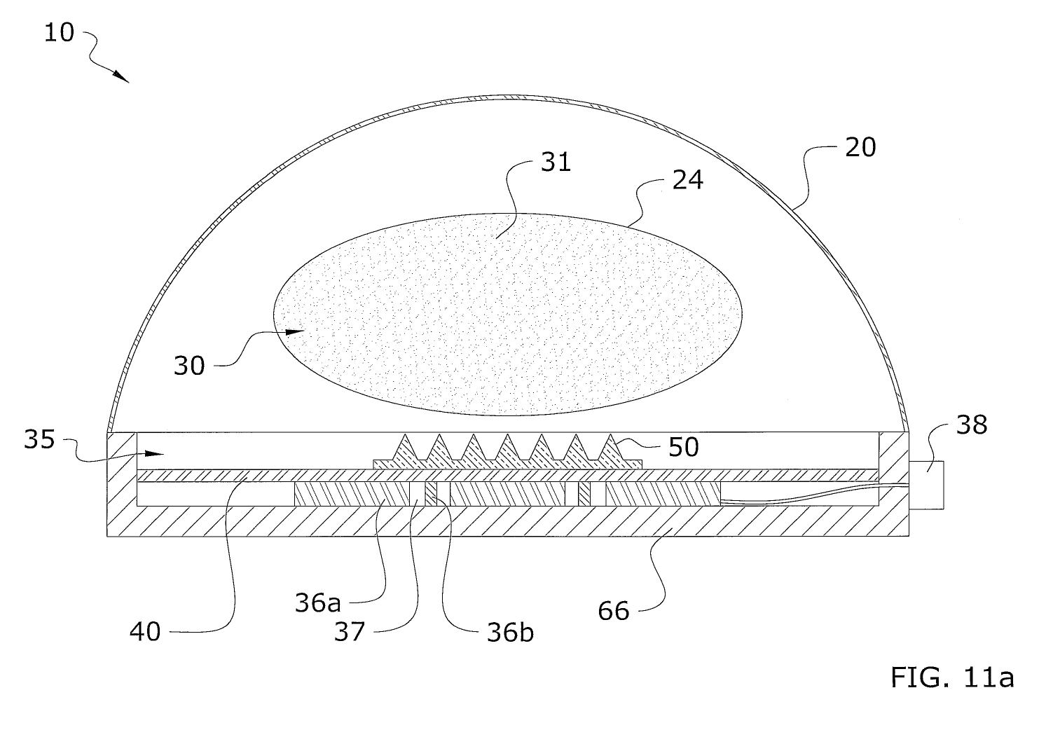

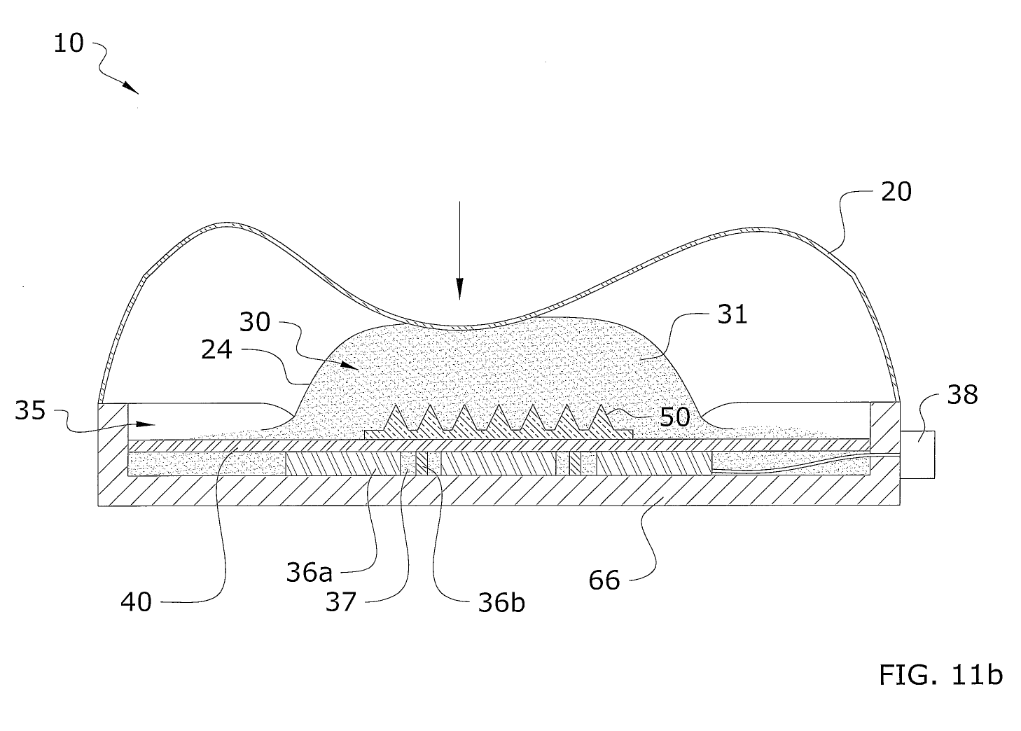

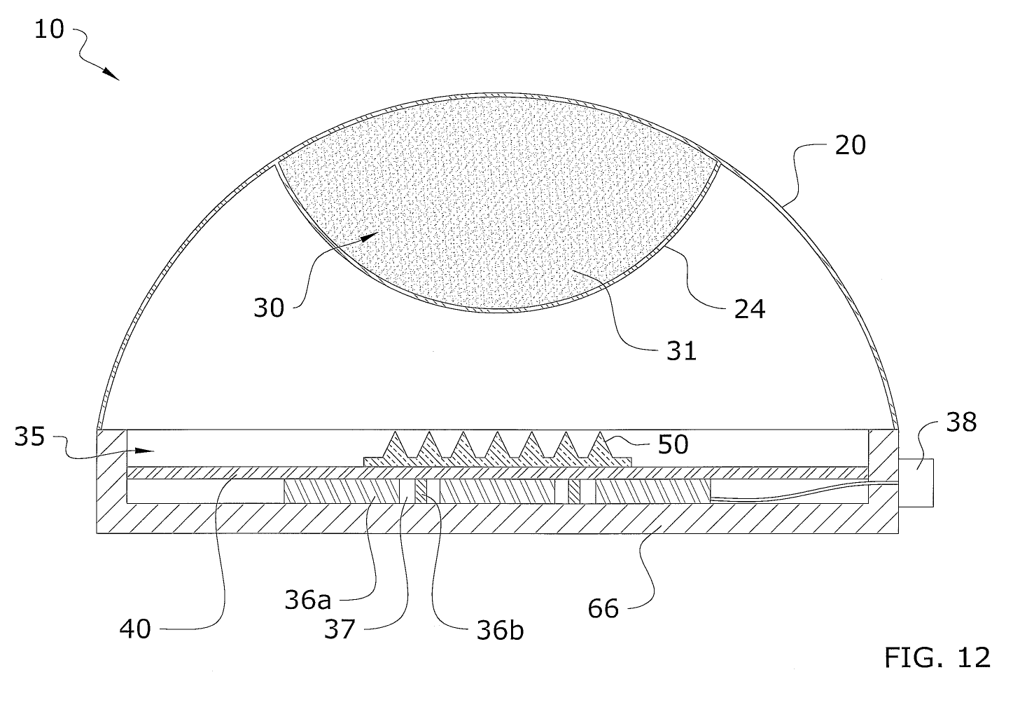

Turning now descriptively to the drawings, in which similar reference characters denote similar elements throughout the several views, FIGS. 1 through 12 illustrate a battery 10 having an outer enclosure 20 including an electrolyte 31 and a plurality of electrodes 36a, 36b separated by at least one breakable, rupturable, or movable barrier 40. The barrier 40 is ruptured via applying a low energy mechanical force to the outer enclosure 20 toward the barrier 40 thus causing the electrolyte 31 to pass through the barrier 40 and come in contact with the electrodes 36a, 36b. The low energy mechanical force may rupture, break, puncture, or move the barrier 40. The outer enclosure 20 may be encased in various electrical devices such as a flashlight housing 71, wherein breaking the barrier 40 allows the light 76 of the flashlight 70 to be activated via providing electrical current to the light 76.

### B. Outer Enclosure

The outer enclosure 20 may be comprised of various sizes and configurations. Preferably the outer enclosure 20 is comprised of a flexible configuration in which a user may manipulate with hand applied pressure (e.g. squeezing, twisting, etc.) to activate the present invention to produce electrical energy through the chemical reaction of the electrolyte 31 and electrodes 36a, 36b. The outer enclosure 20 may be comprised of a hermetic or a non hermetic configuration.

The outer enclosure 20 may be comprised of various materials all of which prevent the electrolyte 31 from leaking from the outer enclosure 20 during use or nonuse and all of which are adapted to last for long durations of time, wherein the present invention may be in nonuse for several years before being activated. The outer enclosure 20 may alternately be comprised of a rigid configuration and include an actuator 54 for activating the present invention through the chemical reaction. The outer enclosure 20 may be large enough to enclose multiple cells 23 for large size batteries or may be small enough to simply enclose a single cell 23 in small size batteries. In one embodiment, the multiple cells 23 may be each separated by a divider wall 26 to each be separately activatable.

Further, a portion of the outer enclosure 20 may be rigid and a portion flexible, such as in embodiments where some cells 23, comprised of a flexible configuration, are to be engaged (to rupture the barrier 40) through the use of low energy mechanical forces, and other cells 23, comprised of a rigid configuration, are to be engaged through the use of an actuator 54. One embodiment of the actuator 54 is shown as the activation switch in the flashlight 70 embodiment of the present invention.

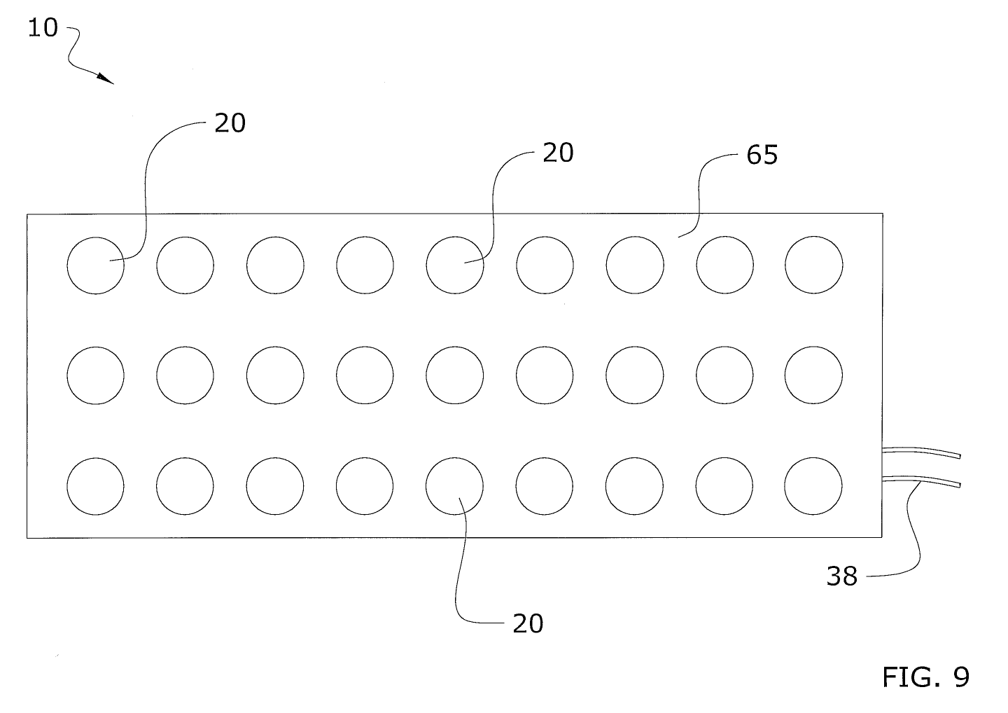

Each of the cells 23 may be defined by the inner wall surface of the outer enclosure 20 or may include a separate inner enclosure 24 that extends inwardly from the outer enclosure 20. The inner enclosure 24 may be flexible, rigid, permeable, or various combinations. The inner enclosure 24 may include further separate side walls 27 and sealants 28 between the side walls 27 and the inner enclosure 24. The inner enclosure 24 may enclose a portion of each of the cells 23 or the entire cell 23. Further each inner enclosure 24 may enclose one cell 23 or a multitude of cells 23. It is also appreciated that the battery 10 may be constructed in various manners, such as loosely inserting the inner enclosure 24 and chamber 35 components within the outer enclosure 20 rather than attaching to the interior of the outer enclosure 20. The inner enclosure 24 or outer enclosure 20 may further alternately be contained within a bubble wrap structure housing 65 configuration as illustrated in FIGS. 9-12.

### C. Electrolyte Reservoir

The battery 10 includes at least one reservoir 30 positioned and hermetically sealed within the outer enclosure 20 or inner enclosure 24 to contain the electrolyte 31. It is appreciated that the present invention may include multiple reservoirs 30 when a multiple cell 23 battery 10 is to be utilized. The reservoir 30 is comprised of a configuration in which the electrolyte 31 may be stored for long durations of time without leakage or other damage to the electrolyte 31.

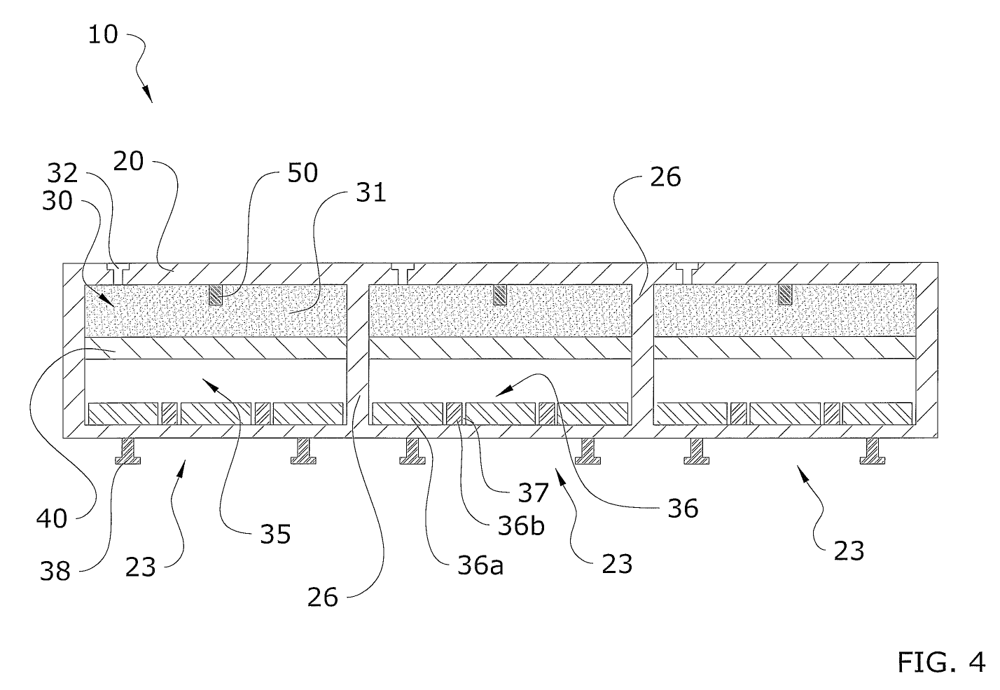

The reservoir 30 may also include at least one fill port 32 fluidly connected to the reservoir 30 and extending towards an outer side of the outer enclosure 20 as shown in FIG. 4. The fill ports 32 allow a user to fill the reservoir 30 with the electrolyte 31 as desired. The reservoir 30 may include a separate casing to hold the electrolyte 31 or may simply be defined by the inner surface of the outer enclosure 20 and the barrier 40.

### D. Electrode Chamber

The present invention includes at least one chamber 35 positioned and hermetically sealed within the outer enclosure 20 or inner enclosure 24 to contain the electrodes 36a, 36b. It is appreciated that the present invention may include multiple chambers 35 when a multiple cell 23 battery 10 is to be utilized. The chambers 35 are separated from the reservoirs 30 so that the electrolyte 31 does not come in contact with the electrodes 36a, 36b when the present invention is not to be utilized.

A plurality of terminals 38 are also preferably connected to the electrodes 36a, 36b and extend to the outer side of the outer enclosure 20 for connecting an electrical device, such as a flashlight 70, to the terminals 38 so that the electrical energy converted from the chemical reaction of the electrolyte 31 and the electrode may be passed through the terminals 38 to the electrical device. The electrodes 36a, 36b may be comprised of stacked configurations or planar relative to each other and may be comprised of various materials, such as lithium/magnesium oxide or zinc/magnesium oxide. The terminals 38 may connect the multiple chambers 35 including the electrodes 36a, 36b in series, parallel or various other configurations.

The electrodes 36a, 36b include at least one cathode 36a and anode 36b which are electrically connected via the electrolyte 31 and are which are separated by a permeable separator 37. The permeable separator 37 may be comprised of various configurations, such as an open space or a permeable material all of which is able to receive and be saturated by the electrolyte 31 to provide an electrical connection between the anode 36b and cathode 36a of the electrodes 36a, 36b.

### E. Barrier

The battery 10 includes at least one barrier 40 preferably within each cell 23 between the reservoir 30 and the chamber 35 to prevent the electrolyte 31 from coming in contact with the electrode when not desired. The barrier 40 prevents any self discharge of the present invention by maintaining a separation between the electrolyte 31 and the electrodes 36a, 36b when not in use. The barrier 40 is ruptured or caused to move so as to expose the electrolyte 31 of the reservoir 30 to the electrodes 36a, 36b of the chamber 35 when the present invention is to be utilized.

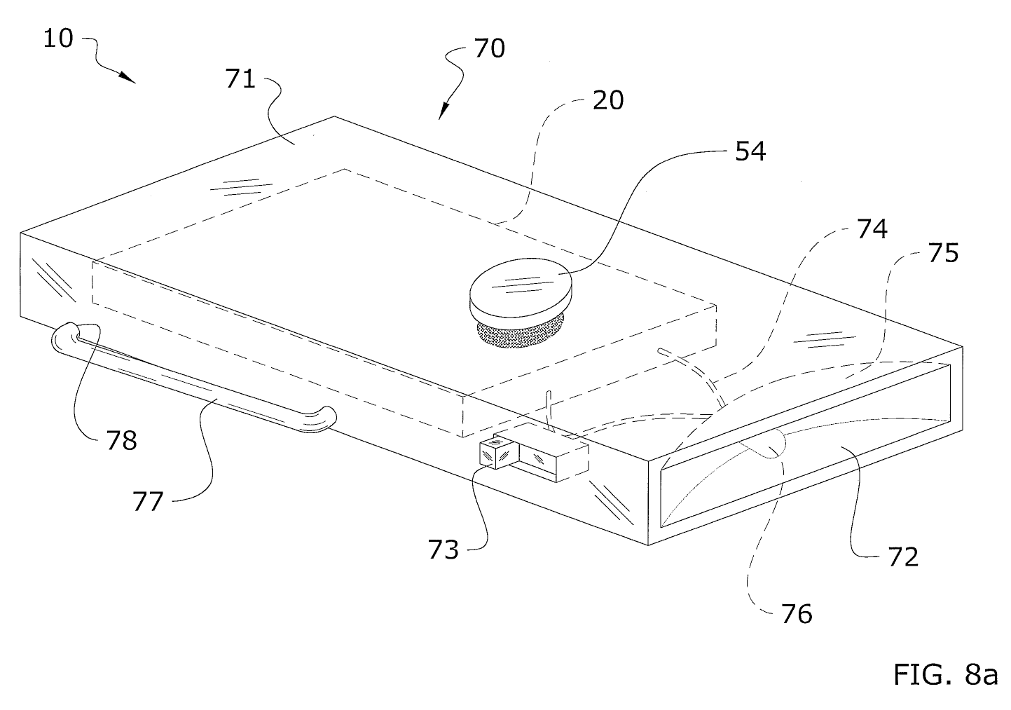

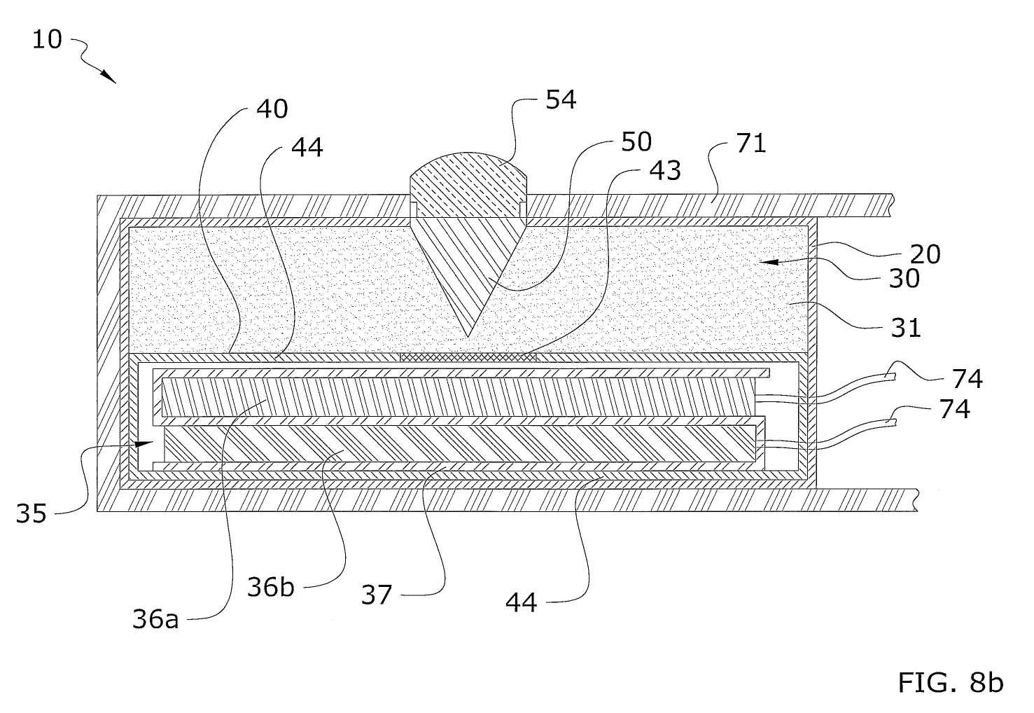

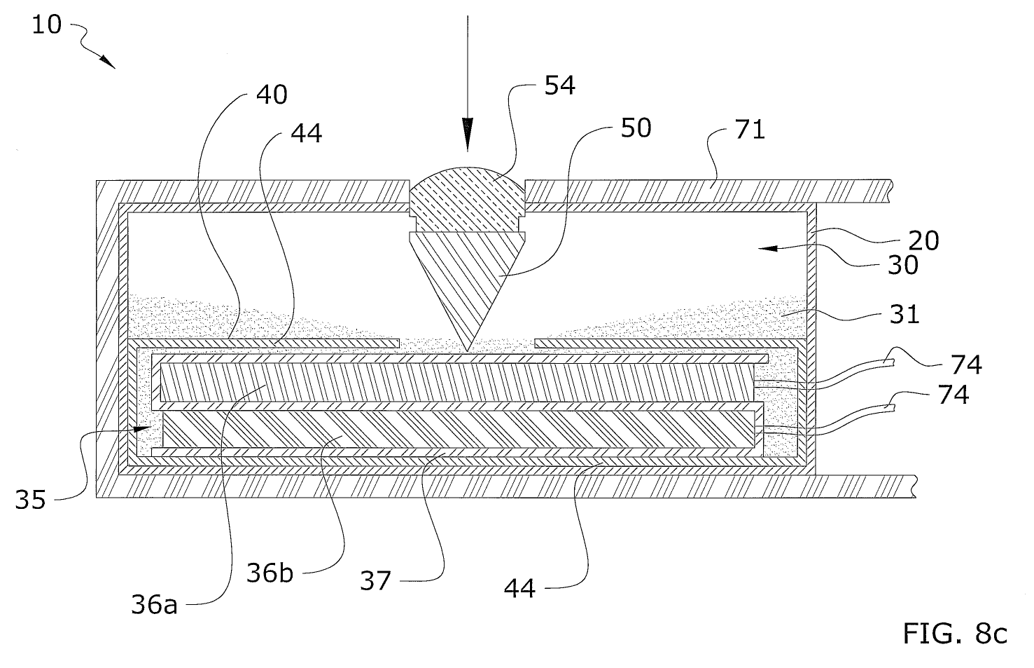

The barrier 40 is broken or caused or caused to be moved via hand pressure applied to the outer enclosure 20 or actuator 54 (or other device) about the outer enclosure 20. The barrier 40 may also include a breakable portion 43 that is broken, moved or altered by the breaking element 50 rather than the entire barrier 40 being breakable and a non breakable portion 44 that is comprised of a structure not to be broken. The breakable portion 43 could extend in the center of the non breakable portion 44 to align with the breaking element 50 or various other locations all which preferably align with the breaking element 50 as illustrated in FIGS. 8b and 8c.

The barrier 40 is preferably comprised of a thin sheet of material and may extend between a single cell 23 or a plurality of cells 23. It is appreciated that for multiple cell 23 batteries, the outer enclosure 20 may include a plurality of barriers 40, 41 each separating an individual or group of cells 23 or the present invention may include a single barrier 40 separating all of the cells 23, wherein when the single barrier 40 is broken all of the cells 23 are activated. The barrier 40 may be comprised of various materials, such as but not limited to glass, mica, metal foil, or polymer that prevents the electrochemical reaction until the barrier 40 is ruptured.

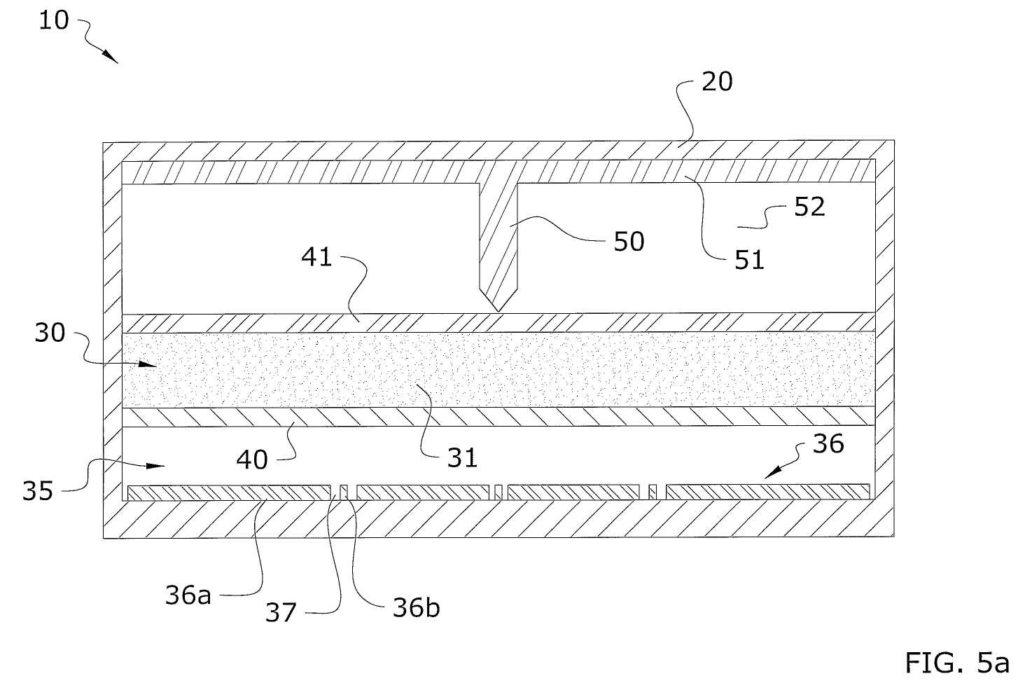

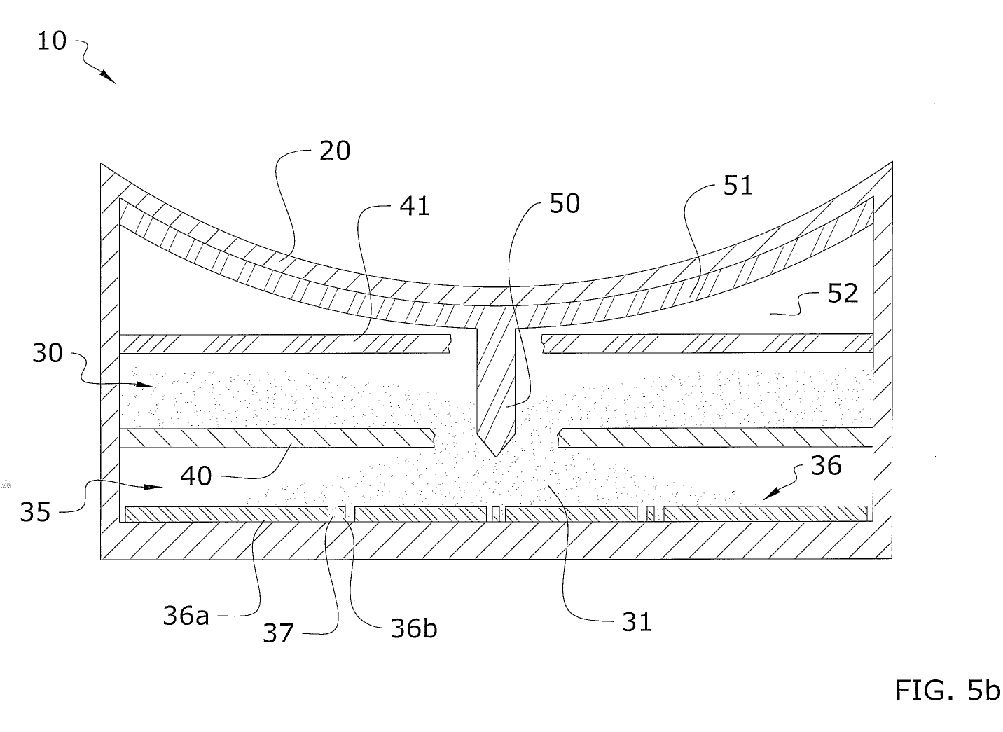

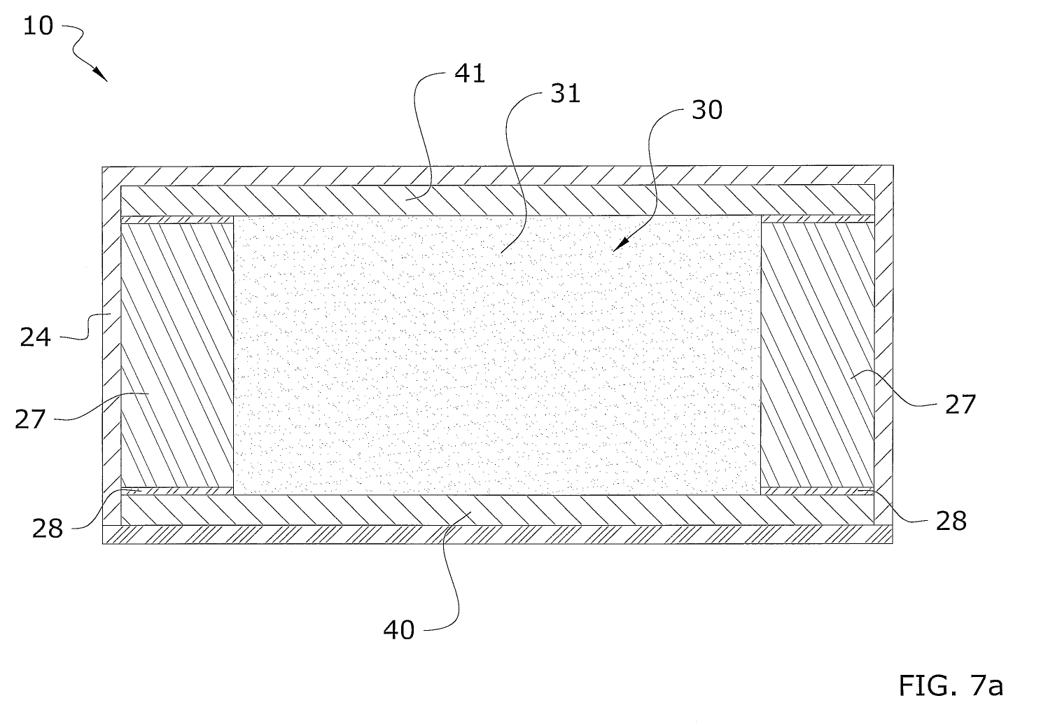

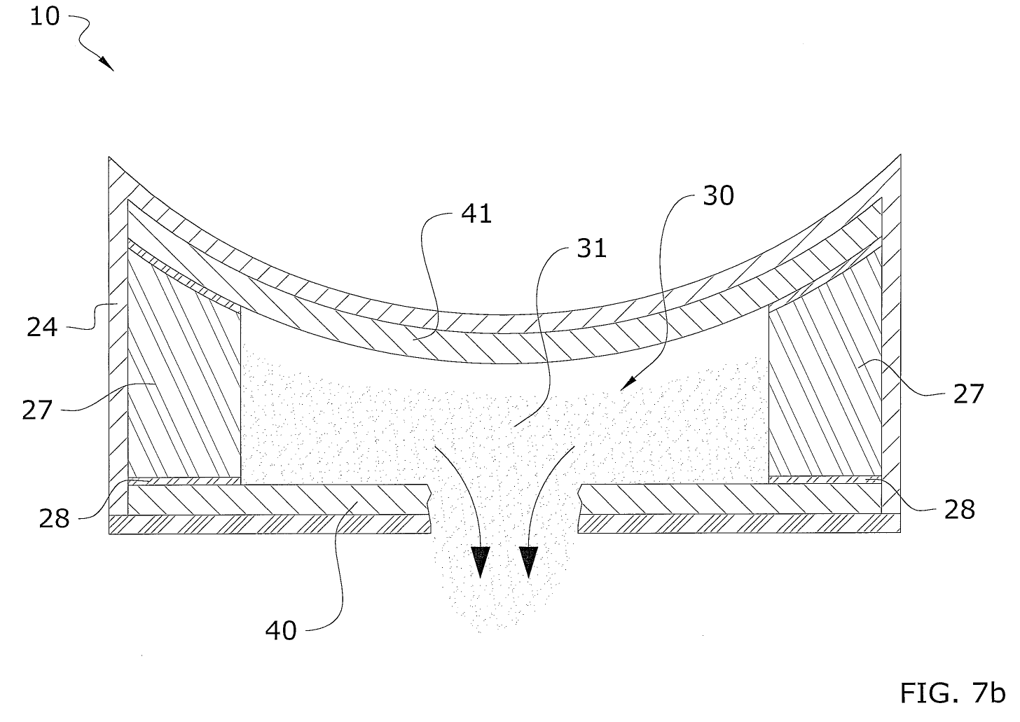

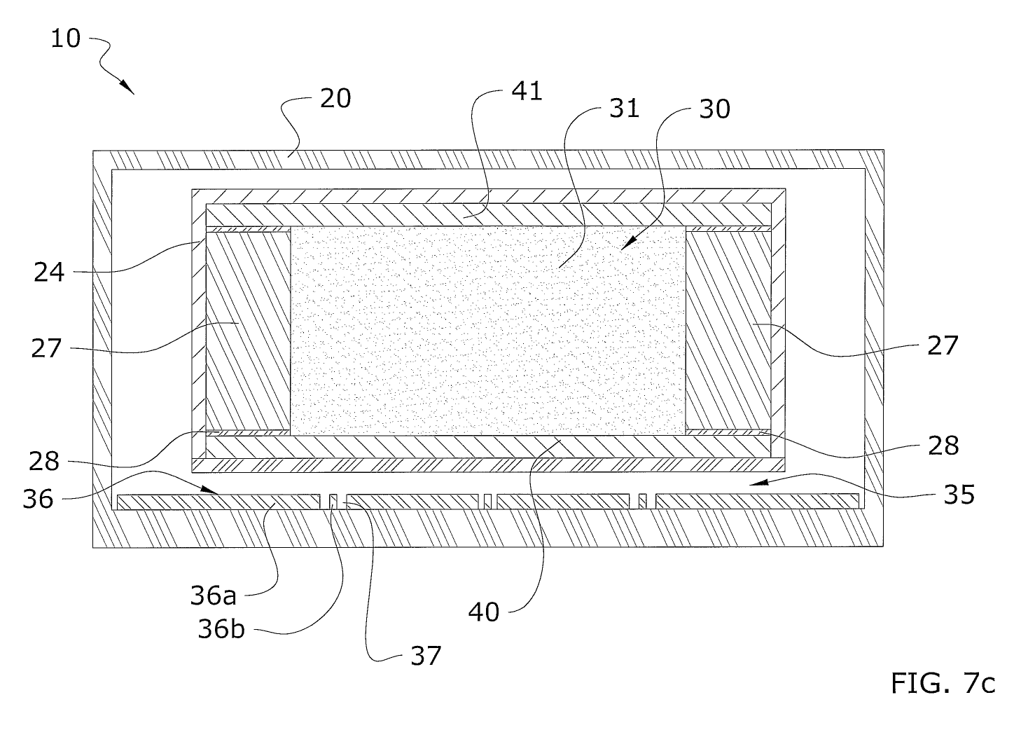

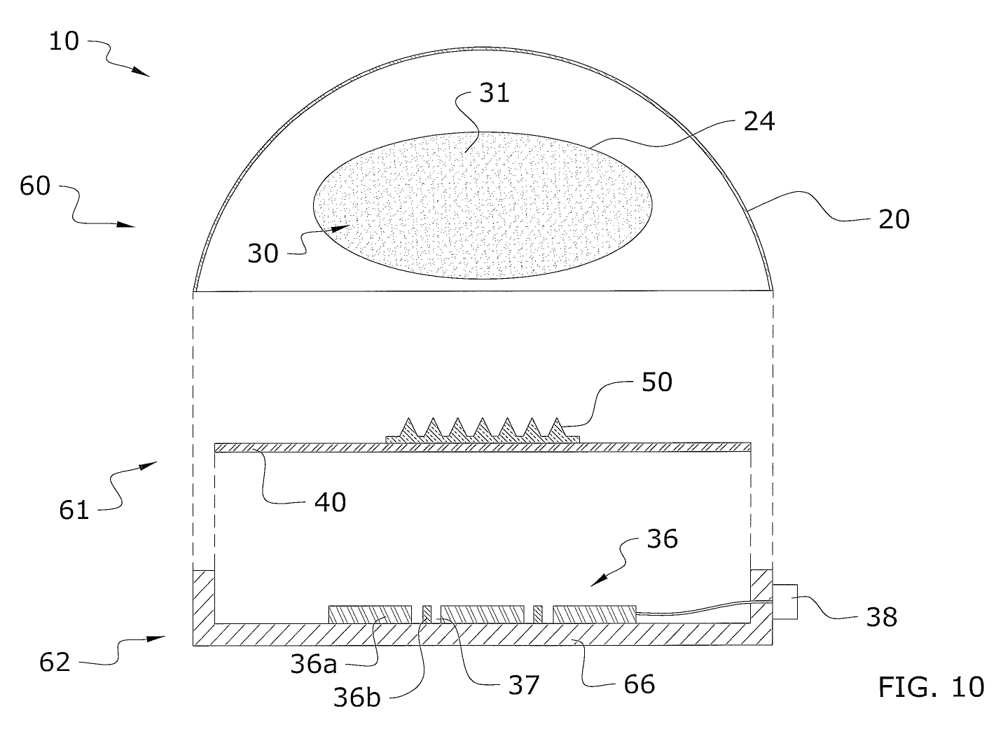

The barrier 40 is generally comprised of a non-porous material; however in some embodiments, such as those using the inner enclosure 24 to surround the reservoir 30, the barrier 40 may be comprised of porous or permeable material as illustrated in FIGS. 10-12. In another alternate embodiment, the reservoir 30 may include a first barrier 40 on one side and a second barrier 41 upon another side as illustrated in FIGS. 5a-7c. The barriers 40, 41 may be connected to side walls 27 (e.g. Teflon™ material) of the outer enclosure 20 via the sealant 28 (e.g. epoxy) as illustrated in FIGS. 7a-7c. In another alternate embodiment, the barrier 40 may surround either the reservoir 30 or the chamber 35 as illustrated in FIGS. 8b-8c.

### F. Breaking Element

The breaking element 50 is utilized to break, rupture, or alter the barrier 40, or in some embodiments the inner enclosure 24, so as to allow the electrolyte 31 to pass through the barrier 40 and come in contact with the electrodes 36a, 36b. The breaking element 50 may be comprised of various configurations and is preferably activated via hand pressure being applied to the outer enclosure 20 or device about the outer enclosure 20 in some manner. The breaking element 50 is preferably internal of the outer enclosure 20 and further preferably in contact with the electrolyte 31 within the reservoir 30. The breaking element 50 may be internal such as to extend from the inside surface of the outer enclosure 20 or comprise the inside surface of the outer enclosure 20.

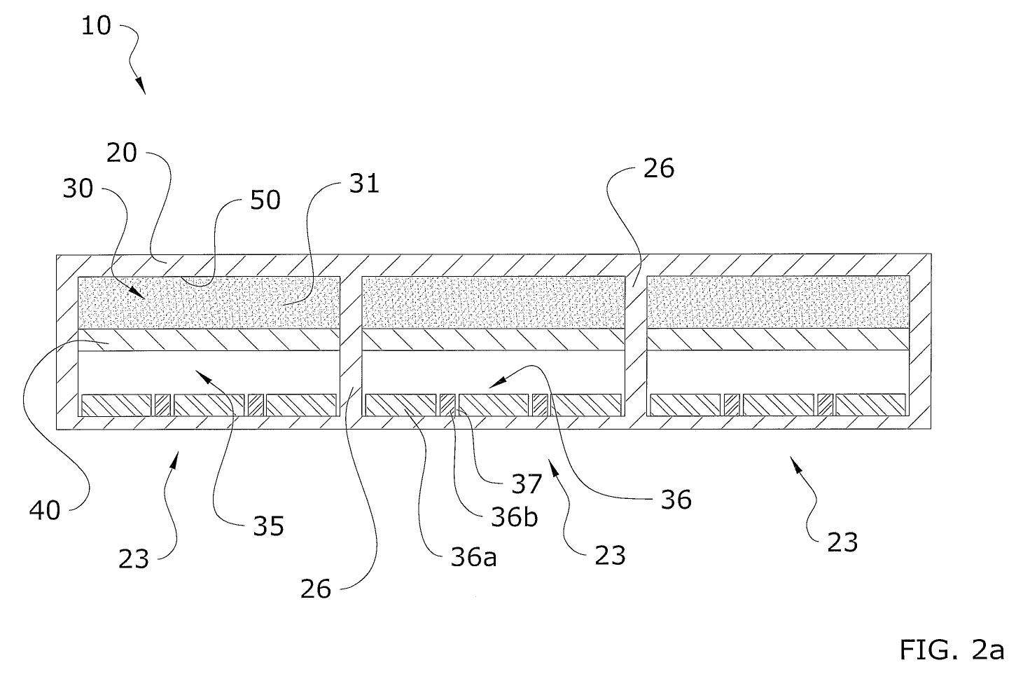

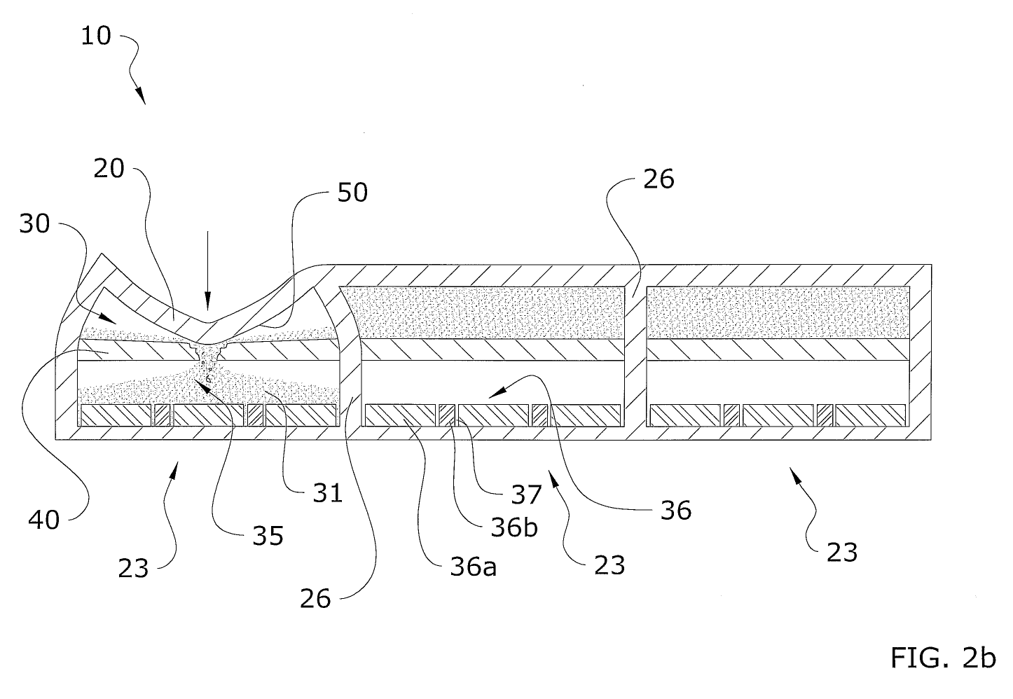

In one embodiment of the present invention, the breaking element 50 is comprised of the direct inner surface of the outer enclosure 20, wherein squeezing the inner surface of the outer enclosure 20 against the barrier 40 causes the barrier 40 to break or alter so that electrolyte 31 may pass through as illustrated in FIGS. 2a-2b. The inner surface of the outer enclosure 20 may be said to be extending from the outer enclosure 20 in that the inner surface extends inwardly from the outer surface of the enclosure. The inner surface, as described, is parallel with the outer surface and is formed from the same integral structure as the outer surface that makes up the outer enclosure 20.

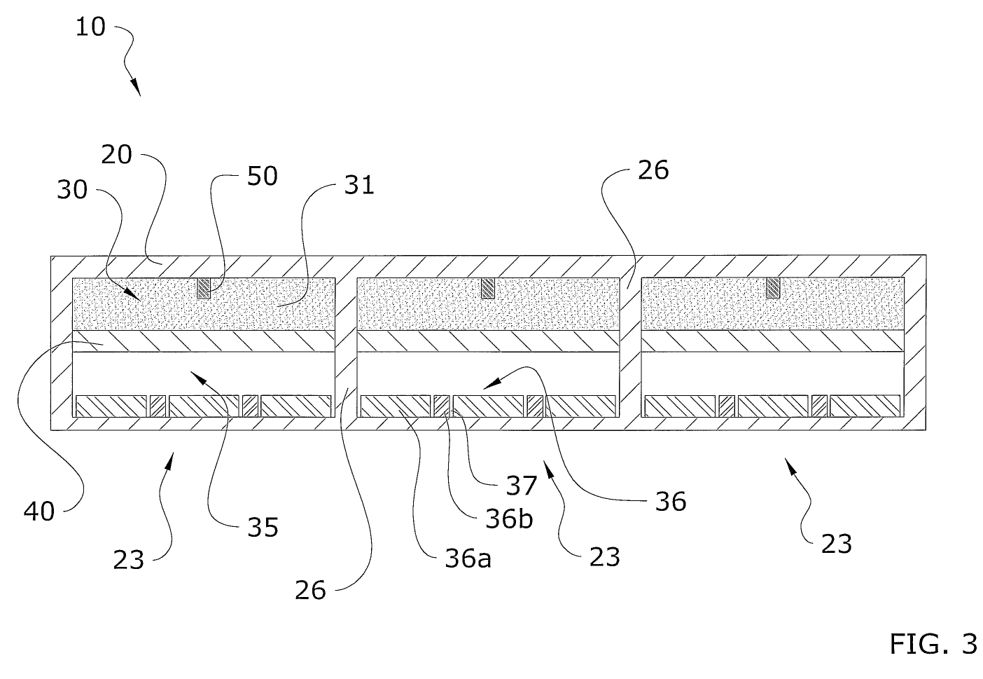

In another embodiment of the present invention, the breaking element 50 is comprised of a contact pin extending toward the breakable element either from the electrolyte 31 side of the electrode side of the outer enclosure 20 as illustrated in FIGS. 3-4. When squeezing, twisting or pounding upon the outer enclosure 20 via hand pressure the breaking element 50 shatters or breaks the breakable element. It is appreciated that multiple contact pins may be utilized, wherein one may be utilized for each cell 23 to ensure a sufficient breakage of the barrier 40. The contact pins may include a blunt contact end or a sharp contact end to rupture the barrier 40.

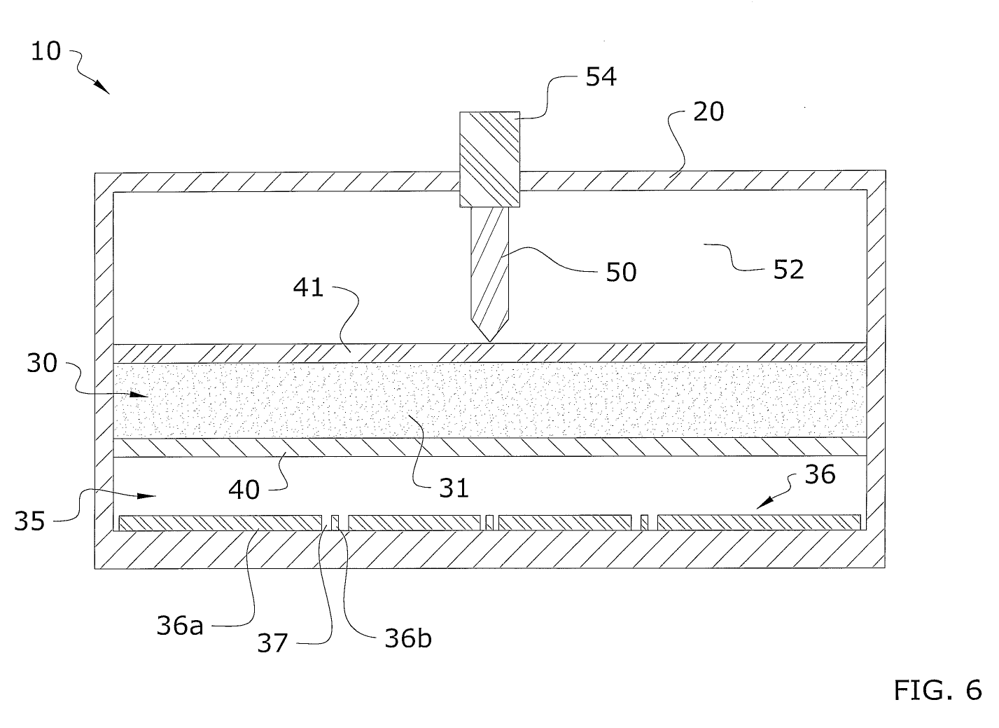

In another embodiment, the breaking element 50 may be actuated via an actuator 54 extending within the outer enclosure 20 as illustrated in FIGS. 6 and 8a-8b. The breaking element 50 extends from the actuator 54 towards the barrier 40 and comes in contact with the barrier 40 to break the barrier 40 when the actuator 54 is pushed towards the barrier 40. The breaking element 50 in this configuration may be comprised of a spike, tapered structure, elongated, various combinations thereof, or other structures in the multiples embodiments of the present invention and breaking element 50. The breaking element 50 (or spike) may include and extend from a movable and flexible inner support 51 which flexes and moves with the outer enclosure 20 toward the barriers 40, 41 as illustrated in FIGS. 5a-6. The breaking element 50 (or spike) further extends within a hollow space 52 in a non activated state. In an activated state, the breaking element 50 breaks the first barrier 40 and the second barrier 41 to release the electrolyte 31 towards the electrodes 36a, 36b. It is appreciated that in the non activated state the first barrier 40, the second barrier 41 and the sides of the outer enclosure 20 hermetically seal the reservoir 30. The breaking element 50 may further extend from an actuator 54, such as a push button, protruding from the outer enclosure 20, wherein the battery 10 is activated by simply pushing on the push button which forces the breaking element 50 through the barriers 40, 41 to release the electrolyte 31.

In yet another embodiment, the breaking element 50 is comprised of a serrated cutter fixedly positioned upon the barrier 40 as illustrated in FIGS. 10-12. In this embodiment, the inner enclosure 24 (which in this embodiment surrounds just the reservoir 30) is moved towards the breaking element 50 via applying pressure upon the outer enclosure 20, which is directly surrounding a portion of the inner enclosure 24. As the inner enclosure 24 comes into contact with the breaking element 50, the breaking element 50 cuts the inner enclosure 24 thus releasing the electrolyte 31, which passes through a permeable barrier 40 to contact the electrodes 36a, 36b. A base 66 may also be used and positioned within the outer enclosure 20 for supporting the electrodes 36a, 36b, wherein the base 66, the electrodes 36a, 36b, the terminals 38, the barrier 40, and the breaking element 50 all form one assembly that may be simply positioned within the outer enclosure 20 as illustrated in FIGS. 10-12.

Construction of the eighth and ninth embodiments as illustrated in FIGS. 10-12 may be achieved in various manners, such as but not limited to the following example. The electrolyte 31 is first encapsulated between two layers of polymer film to form a breakable pod or multiple pods as desired. It is appreciated that only one layer may be used to form the bottom layer holding the electrolyte 31 to come in contact with the breaking element 50, wherein that layer would subsequently be sealed to the outer enclosures 20 which will be described subsequently. The pods (or inner enclosures 24) are then inserted within hollow cone structures (outer enclosures 20) in which a polymer is inserted which may be flexible or rigid and may sit loosely within a hollow space of outer enclosures 20. The outer enclosures 20 separate each inner enclosure 24 from one another which may prove useful if one or more of the inner enclosures 24 leak. The outer enclosures 20 enclose a top of the inner enclosures 24, wherein the bottom of the outer enclosures 20 is sealed or bonded to the second assembly 61 including the porous barrier 40 and breaking element 50 which is attached to a third assembly 62 including the electrodes 36a, 36b, the base 66, and the terminals 38 as described in the previous paragraph. The second assembly 61 and the third assembly 62 are hermetically sealed from an ambient environment via sidewall portions of the base 66 extending toward the first assembly 60 to seal with either the outer enclosure 20 or the perimeter of the porous membrane.

When depressed, the individual electrolyte 31 inner enclosure 24 is pressed into the top of the serrated blade (or breaking element 50) which ruptures the inner enclosure 24 and activates the battery 10 by releasing the electrolyte 31 from the inner enclosure 24 to contact the electrodes 36a, 36b. The porous barrier 40 is thus in direct communication with the inner enclosure 24 and in direct communication with the electrodes 36a, 36b from an opposite side. It is appreciated that the rupturing element and attached porous barrier 40 may be separately attached to the base 66, terminals 38 and electrodes 36a, 36b to form a first assembly 60 including the outer enclosure 20, inner enclosure 24, and electrolyte 31, and the second assembly 61 including the rupturing element and the porous barrier 40, and the third assembly 62 including the base 66, terminals 38 and electrodes 36a, 36b. Alternately, any of the assemblies 60, 61, 62 may be integral with any of the other assemblies 60, 61, 62. The outer enclosure 20 is preferably comprised of a bubble wrap structure in this embodiment for providing an easily activatable battery 10; however other configurations may be appreciated. The forming of the inner enclosures 24 and outer enclosures 20 may be accomplished with cubed trays or various other support structures.

The outer enclosure 20 may further include a separate or integral push button cap and is comprised of an elastic structure and may be positioned within a housing that may include a multitude of outer enclosures 20. The inner enclosure 24 is also preferably comprised of an elastic structure. The base 66 is also comprised of an electrically insulating structure. The porous barrier 40 may be comprised of a wire mesh structure among other configurations.

### G. Flashlight Configuration

The outer enclosure 20 may be utilized in an electrical device, such as a flashlight 70 as illustrated in FIGS. 8a-8c. The housing 71 is preferably comprised of a rectangular shaped configuration lining the outer sides of the outer enclosure 20 of the present invention. The housing is further preferably comprised of a thin (approximately 0.5″ thick) and flat configuration. The flashlight 70 configuration of the present invention includes various components so that the flashlight 70 will function properly, such as a lens 72, a power switch 73, an activation switch, a reflector casing 75, a light 76 and wires 74 connecting the light 76 to the terminals 38 of the outer enclosure 20.

The activation switch is preferably comprised of a push button configuration and is positioned upon the breaking element 50 of the outer enclosure 20. Thus, when pushing down upon the activation switch, the breaking element 50 is also pushed down and subsequently breaks the barrier 40. It is appreciated that in various embodiments, the activation switch may function in a manner similar to that of the actuator 54. The wires 74 are interconnected between the terminals 38, the light 76 and the power switch 73. Once the barrier 40 is broken or moved so the electrolyte 31 can contact the electrodes 36a, 36b, the light 76 may be turned on and off via the power switch 73. The light 76 is preferably comprised of a high brightness LED (greater than 20 lumen). An S-shaped permeable separator 37 separates the anodes 36b and the cathodes 36a and is positioned within the interior of the barrier 40.

The barrier 40 in this embodiment surrounds the chamber 35 and includes a breakable portion 43 and a non breakable portion 44. The breakable portion 43 only extends a small area along the top of the barrier 40 to come in contact with the breaking element 50. The breakable portion 43 and the non breakable portion 44 may be comprised of similar materials; however are preferably comprised of different materials.

The housing 71 may also include a pivotal stand 77 extending from the housing so that the housing may be propped in an upward or angular manner so as to direct the light 76 in a desired direction. A notch 78 may also be extending within the housing to receive the cross-wise portion of the stand 77 so that the stand 77 is flush with the bottom side of the housing and the housing may be positioned flat upon another flat surface.

### H. Operation of Pref erred Embodiment

Activation of the present invention is caused by a mechanical action on the barrier 40 such that the electrolyte 31 is allowed to come in contact with the electrodes 36a, 36b creating a chemical reaction which results in a voltage and provides energy capacity of the active materials comprising the present invention. The barrier 40 is breached via any number of methods such as applying low energy mechanical force (i.e. hand pressure) to rupture, break, puncture, or move the barrier 40. The force may be applied to the outer enclosure 20, an actuator 54, activation switch or various other devices. The battery 10 may be used in various consumer electrical devices, such as a flashlight 70, and may be comprised of various sizes.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A reserve battery, comprising:
an outer enclosure comprised of a flexible structure;
at least one breaking element extending directly from said outer enclosure toward an interior of said outer enclosure;
at least one reservoir hermetically sealed within said outer enclosure;
an electrolyte contained within said at least one reservoir; and
at least one breakable barrier positioned within said outer enclosure;
at least one chamber hermetically sealed within said outer enclosure, wherein said at least one chamber is separated from said at least one reservoir via said at least one breakable barrier; and
a plurality of electrodes contained within said at least one chamber;
wherein said plurality of electrodes receive said electrolyte to activate said battery when inward manual pressure is applied to said outer enclosure causing said at least one breaking element to move inwardly to break at least a portion of said breakable barrier and allow passage of said electrolyte from within said at least one reservoir to within said at least one chamber to connect said plurality of electrodes.

2. The reserve battery of claim 1, wherein said at least one breaking element is comprised of a direct inner surface of said outer enclosure.

3. The reserve battery of claim 1, wherein said at least one breaking element is comprised of a contact pin.

4. The reserve battery of claim 1, wherein said at least one breaking element includes an inner support, wherein said inner support extends along an inner surface of said outer enclosure and wherein said at least on breaking element extends inwardly from said inner support.

5. The reserve battery of claim 4, wherein said at least one breaking element extends within a hollow space defined within said outer enclosure.

6. The reserve battery of claim 5, wherein said inner support is comprised of a flexible structure to move inwardly with said outer enclosure.

7. The reserve battery of claim 6, wherein said at least one breakable barrier includes a first breakable barrier enclosing a top of said at least one reservoir and a second breakable barrier enclosing a bottom of said at least one reservoir, wherein said at least one breaking element extends through said first breakable barrier and said second breakable barrier.

8. The reserve battery of claim 1, wherein said at least one breakable barrier includes a first breakable barrier enclosing a top of said at least one reservoir and a second breakable barrier enclosing a bottom of said at least one reservoir.

9. The reserve battery of claim 8, wherein said at least one breaking element extends through said first breakable barrier and said second breakable barrier.

10. The reserve battery of claim 8, including an inner enclosure to surround said first breakable barrier and said second breakable barrier.

11. The reserve battery of claim 1, wherein said at least one breakable barrier includes a breakable portion and a non breakable portion, wherein said breakable portion is aligned with said at least one breaking element.

12. The reserve battery of claim 11, wherein said at least one breakable barrier surrounds said at least one chamber.

13. The reserve battery of claim 1, including at least one fill port extending through said outer enclosure for refilling said at least one reservoir with said electrolyte.

14. The reserve battery of claim 1, including a permeable separator to separate at least one anode and at least one cathode of said plurality of electrodes.

15. The reserve battery of claim 1, wherein said outer enclosure is positioned within a flashlight housing.

16. A reserve battery, comprising:
a first assembly having:
an electrolyte;
an inner enclosure encapsulating said electrolyte, wherein said inner enclosure is comprised of a breakable structure; and
an outer enclosure partially surrounding said inner enclosure, wherein said outer enclosure is comprised of a flexible structure;
a second assembly connected to said outer enclosure of said first assembly so that said inner enclosure is in direct communication with said second assembly, said second assembly having:
a porous barrier in communication with said inner enclosure for receiving said electrolyte from said inner enclosure; and
a breaking element connected to said porous barrier, wherein said breaking element faces said inner enclosure to break said inner enclosure when inward pressure is applied to said outer enclosure causing said inner enclosure to press against said breaking element; and
a third assembly connected to said second assembly opposite said first assembly, said third assembly having:
a base;
a plurality of electrodes attached to said base, wherein said plurality of electrodes are in communication with said porous barrier for receiving said electrolyte released from said inner enclosure that travels through said porous barrier; and
a plurality of terminals extending from said plurality of electrodes for transferring an electrical current formed by said plurality of electrolytes connecting said plurality of electrodes.

17. The reserve battery of claim 16, wherein said outer enclosure is comprised of a partial bubble from a bubble wrap structure.

18. The reserve battery of claim 16, wherein said breaking element is comprised of a serrated blade.

19. The reserve battery of claim 16, wherein said first assembly, said second assembly, and said third assembly are hermetically sealed to an ambient environment.

20. A reserve battery, comprising:
an outer enclosure comprised entirely of a flexible structure; and
a plurality of cells positioned within said outer enclosure;
wherein each of said plurality of cells are separate and separately activatable, wherein each of said plurality of cells has:
at least one breaking element extending directly from said outer enclosure toward an interior of said outer enclosure;
wherein said at least one breaking element includes an inner support, wherein said inner support extends along an inner surface of said outer enclosure and wherein said at least on breaking element extends inwardly from said inner support;
wherein said at least one breaking element extends within a hollow space defined within said outer enclosure;
wherein said inner support is comprised of a flexible structure to move inwardly with said outer enclosure;
a hermetically sealed within said outer enclosure;
an electrolyte contained within said at least one reservoir;
at least one breakable barrier positioned within said outer enclosure;
wherein said at least one breakable barrier includes a first breakable barrier enclosing a top of said at least one reservoir and a second breakable barrier enclosing a bottom of said at least one reservoir;
wherein said at least one breaking element extends through said first breakable barrier and said second breakable barrier;
a chamber hermetically sealed within said outer enclosure, wherein said chamber is separated from said reservoir via said at least one breakable barrier;
a plurality of electrodes contained within said chamber; and
a permeable separator to separate at least one anode and at least one cathode of said plurality of electrodes;
wherein said plurality of electrodes receive said electrolyte to activate said battery when inward manual pressure is applied to said outer enclosure causing said at least one breaking element to move inwardly to break at least a portion of said breakable barrier and allow passage of said electrolyte from within said reservoir to within said chamber to connect said plurality of electrodes.
